(19) United States
(12) Patent Application Publication
(10) Pub. No.: US 2026/0316634 A1
(43) Pub. Date: Oct. 15, 2026

(54) SEAT CONTROL METHOD AND SEAT CONTROL DEVICE

(71) Applicant: Nissan Motor Co., Ltd., Kanagawa (JP)

(72) Inventors: Yasutomo Sasanuma, Kanagawa (JP); Natsuko Nagasawa, Kanagawa (JP); Masashi Okumura, Kanagawa (JP); Daiki Toyooka, Kanagawa (JP); Akari Kamada, Kanagawa (JP)

(73) Assignee: Nissan Motor Co., Ltd., Kanagawa (JP)

(21) Appl. No.: 19/484,291

(22) PCT Filed: May 30, 2023
(86) PCT No.: PCT/JP2023/020128

§ 371 Date: Nov. 13, 2025

(51) Int. Cl. B60N 2/02; B60N 2/12

(52) U.S. Cl. CPC B60N 2/0233; B60N 2/12

(57) ABSTRACT

A seat control method and a seat control device displays on an operation display unit: a seat icon indicating a seat mounted in a vehicle; a first icon indicating a first movement direction of the seat when activating a walk-in function of the seat; a second icon indicating a second movement direction opposite to the first movement direction; and a stop icon disposed between the first icon and the second icon. Based on a first operation on the first icon, the seat is moved in the first movement direction; based on a second operation on the second icon, the seat is moved in the second movement direction; and based on a stop operation on the stop icon, movement of the seat is stopped.

### TECHNICAL FIELD

The present disclosure relates to a seat control method and a seat control device.

### BACKGROUND ART

Patent Literature 1 proposes technology related to an interface that controls individual adjustment of each component (seat cushion, backrest, etc.) constituting a vehicle seat based on operations received via a touch panel.

### CITATION LIST

### Patent Literature

Patent Literature 1: Japanese Patent Application Laid-Open No. 2010-285148

### SUMMARY OF INVENTION

### Technical Problem

However, according to the technology described in Patent Literature 1, there is a problem that multiple operations need to be performed to realize a walk-in function that moves the positions of both the seat cushion and backrest forward in the vehicle. Furthermore, there is a problem that operations become complicated because the period during which adjustment of each component is controlled is limited to the period during which the user is touching the touch panel.

The present disclosure has been made in view of the above problems. Its objective is to provide a seat control method and seat control device that can simplify operations when realizing the walk-in function and suppress such operations from becoming complicated.

### Solution to Problem

To solve the above-mentioned problems, the seat control method and seat control device according to one aspect of the present disclosure display on an operation display unit: a seat icon indicating a seat mounted in a vehicle; a first icon indicating a first movement direction of the seat when activating the walk-in function of the seat; a second icon indicating a second movement direction opposite to the first movement direction; and a stop icon disposed between the first icon and the second icon. Based on a first operation on the first icon, the seat is moved in the first movement direction; based on a second operation on the second icon, the seat is moved in the second movement direction; and based on a stop operation on the stop icon, movement of the seat is stopped.

### Advantageous Effects of Invention

According to the present disclosure, operations when realizing the walk-in function can be simplified, and such operations can be prevented from becoming complicated.

### BRIEF DESCRIPTION OF DRAWINGS

FIG. 1 is a block diagram showing the configuration of a seat control device according to an embodiment of the present disclosure.

FIG. 2 is a diagram showing an example of a user interface screen.

FIG. 3 is a diagram showing an example of icon display for the walk-in function.

FIG. 4 is a diagram showing an example of a first animation.

FIG. 5 is a diagram showing an example of a second animation.

FIG. 6 is a diagram showing an example of message display.

FIG. 7 is a diagram showing a time chart when executing the walk-in function.

FIG. 8 is a flowchart showing the processing procedure when executing the walk-in function.

FIG. 9 is a diagram showing an example of a user interface screen for the folding function.

FIG. 10 is a diagram showing a time chart when executing the folding function.

FIG. 11 is a flowchart showing the processing procedure when executing the folding function.

### DESCRIPTION OF EMBODIMENTS

Next, embodiments of the present disclosure will be described in detail with reference to the drawings. In the description, the same reference numerals are assigned to the same elements, and duplicate descriptions are omitted.

### Configuration of Seat Control Device

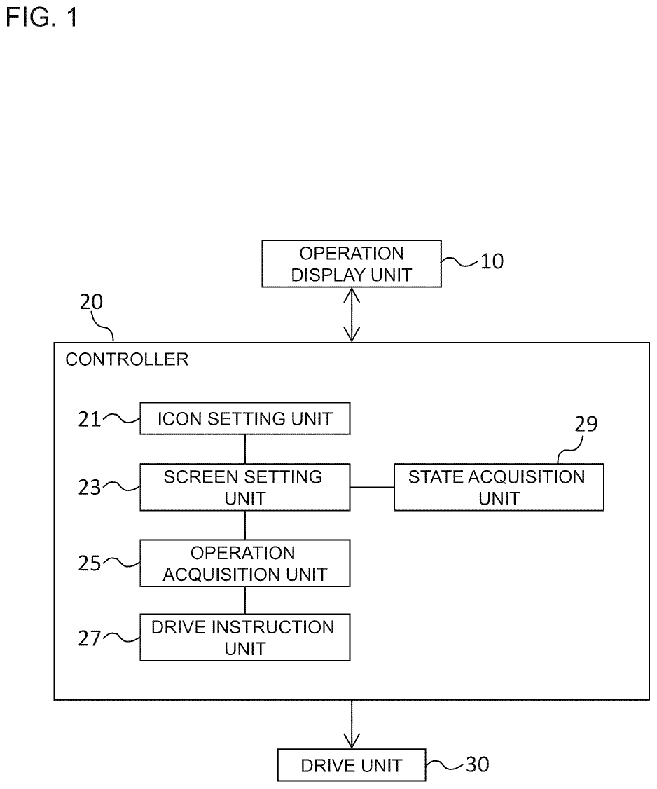

FIG. 1 is a block diagram showing the configuration of a seat control device according to an embodiment of the present disclosure. The seat control device includes an operation display unit 10, a controller 20, and a drive unit 30.

The controller 20 is communicatively connected to the operation display unit 10 and the controller 20, respectively. The controller 20 and operation display unit 10, and the controller 20 and drive unit 30 are connected by wired or wireless communication paths. The drive unit 30 is mounted in the vehicle for adjustment of seats mounted in the vehicle, but the operation display unit 10 and controller 20 may not be mounted in the vehicle.

The operation display unit 10 is means for presenting information to the user by outputting user interface screens generated by the controller 20 described later, and for receiving input operations performed by the user. Specifically, the operation display unit 10 comprises a touch panel and its control means, and a liquid crystal display and its control means. The touch panel and liquid crystal display constitute one touch panel display in this embodiment. The operation display unit 10 displays user interface screens generated by the controller 20.

The drive unit 30 is means for adjusting each component constituting the vehicle seat according to instructions from the controller 20 described later. The drive unit 30 is provided for each seat of the vehicle and adjusts the position and angle of each component constituting the seat. The drive unit 30 is an electric or hydraulic actuator, but is not limited to the examples given here. Examples of “each component constituting the seat” include the seat cushion, backrest, headrest, armrest, footrest, etc.

For example, when executing the walk-in function of a seat, the drive unit 30 moves the seat in the first movement direction (forward direction of the vehicle). More specifically, the drive unit 30 advances the seat cushion of the seat and tilts the backrest of the seat forward. The walk-in function is a function that makes it easier to get in and out of seats behind the relevant seat by moving the seat forward in the vehicle in this way.

On the other hand, when canceling the walk-in function of a seat, the drive unit 30 moves the seat in the second movement direction (rearward direction of the vehicle) opposite to the first movement direction. More specifically, the drive unit 30 moves the seat cushion of the seat backward and returns the backrest of the seat rearward. For example, the drive unit 30 returns the seat position to a pre-registered normal use state,

In addition, when executing the folding function of a seat, the drive unit 30 folds the backrest of the seat. More specifically, the drive unit 30 tilts the backrest of the seat forward. For example, by executing the folding function for the rear seats of the vehicle, rear space in the vehicle interior can be secured to enable cargo loading, etc.

On the other hand, when canceling the folding function of a seat, the drive unit 30 unfolds the backrest of the seat. More specifically, the drive unit 30 returns the backrest of the seat rearward. For example, the drive unit 30 returns the backrest position to a pre-registered normal use state.

The controller 20 (an example of a control unit or processing unit) is a general-purpose computer equipped with a CPU (central processing unit), memory, and input/output unit. A computer program (seat control program) for functioning as part of the seat control device is installed in the controller 20. By executing the computer program, the controller 20 functions as multiple information processing circuits (21, 23, 25, 27, 29) included in the seat control device.

Here, an example is shown where multiple information processing circuits (21, 23, 25, 27, 29) included in the seat control device are realized by software. However, it is also possible to prepare dedicated hardware for executing each information processing shown below to configure the information processing circuits (21, 23, 25, 27, 29). Also, the multiple information processing circuits (21, 23, 25, 27, 29) may be configured by individual hardware. Furthermore, the information processing circuits (21, 23, 25, 27, 29) may be combined with electronic control units (ECUs) used for other vehicle-related control.

The controller 20 includes, as multiple information processing circuits (21, 23, 25, 27, 29), an icon setting unit 21, a screen setting unit 23, an operation acquisition unit 25, a drive instruction unit 27, and a state acquisition unit 29.

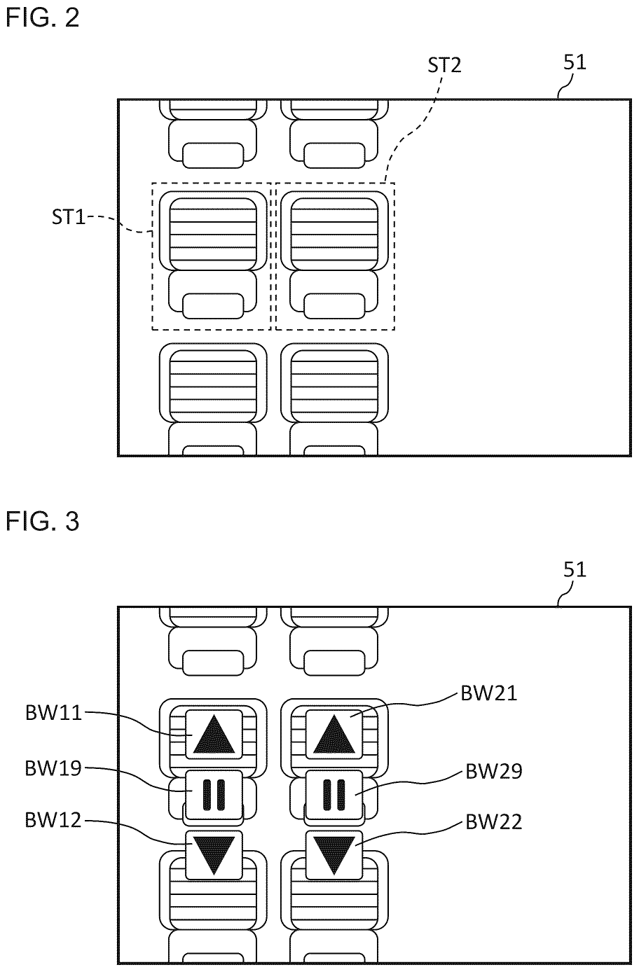

The icon setting unit 21 sets icons to be set on the user interface screen. For example, the icon setting unit 21 sets icons (seat icons) corresponding to a top view of vehicle seats as shown in FIG. 2. FIG. 2 shows the arrangement of seats in a three-row seat vehicle, and seat icons ST1 and ST2 are shown as seat icons corresponding to the second row seats.

The icon setting unit 21 may change seat icons according to the operation status of the walk-in function or folding function. For example, the icon setting unit 21 may display seat icons with a first animation having movement corresponding to the first movement direction when moving the seat in the first movement direction. Also, the icon setting unit 21 may display seat icons with a second animation having movement corresponding to the second movement direction when moving the seat in the second movement direction.

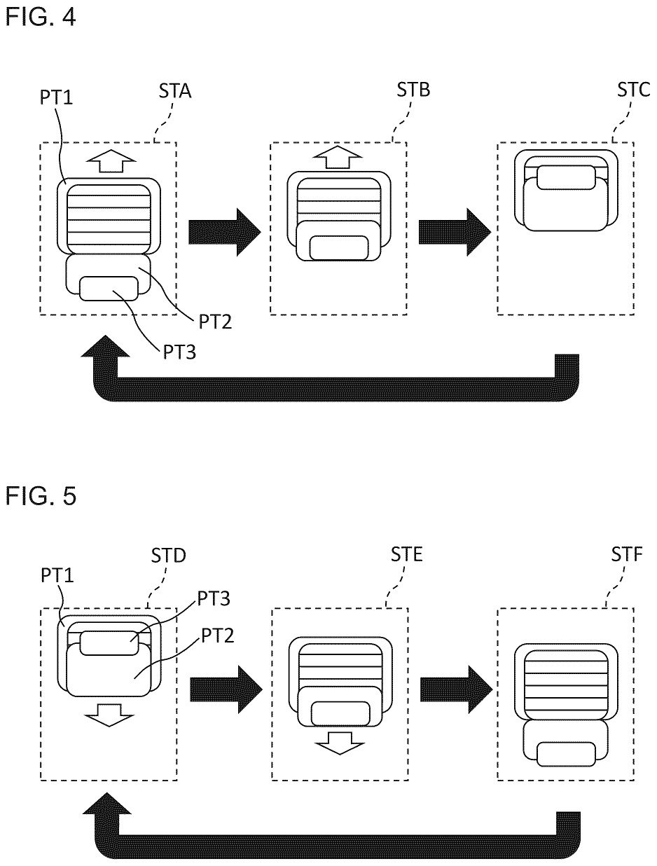

Here, the “first animation” is an animation showing the state of moving each part of the seat toward the first movement direction. FIG. 4 shows three of the multiple still images constituting the first animation. The first animation expresses the movement of moving each part of the seat toward the first movement direction by sequentially repeating seat icons STA, STB, and STC. In FIG. 4, it can be seen that the seat cushion PT1, backrest PT2, and headrest PT3 are moving upward (first movement direction) in the drawing in the order of seat icons STA, STB, and STC.

Also, the “second animation” is an animation showing the state of moving each part of the seat toward the second movement direction. FIG. 5 shows three of the multiple still images constituting the second animation. The second animation expresses the movement of moving each part of the seat toward the second movement direction by sequentially repeating seat icons STD, STE, and STF. In FIG. 5, it can be seen that the seat cushion PT1, backrest PT2, and headrest PT3 are moving downward (second movement direction) in the drawing in the order of seat icons STD, STE, and STE.

The icon setting unit 21 may set icons for operation buttons related to the walk-in function. For example, operation buttons related to the walk-in function include an execute button that executes the walk-in function, a cancel button that cancels the walk-in function, and a stop button that stops seat movement during execution/cancellation of the walk-in function. The icon setting unit 21 may set an “execute icon” (first icon) corresponding to the execute button, a “cancel icon” (second icon) corresponding to the cancel button, and a “stop icon” corresponding to the stop button.

FIG. 3 shows an example of the “execute icon,” “cancel icon,” and “stop icon.” FIG. 3 shows execute icon BW11, cancel icon BW12, and stop icon BW19 displayed to execute the walk-in function of seat icon ST1 shown in FIG. 2. Furthermore, execute icon BW21, cancel icon BW22, and stop icon BW29 displayed to execute the walk-in function of seat icon ST2 shown in FIG. 2 are shown.

The “stop icon” may be positioned between the “execute icon” and the “cancel icon.”

In FIG. 3, from top to bottom in the drawing, they are arranged in the order of execute icon BW11, stop icon BW19, and cancel icon BW12. Similarly, from top to bottom in the drawing, they are arranged in the order of execute icon BW21, stop icon BW29, and cancel icon BW22. In FIG. 3, the upper direction corresponds to the first movement direction, and the lower direction corresponds to the second movement direction. Therefore, by arranging icons in the order of “execute icon,” “stop icon,” and “cancel icon” from top to bottom in the drawing, users can understand the operation content by icons.

The icon setting unit 21 may change icons of operation buttons related to the walk-in function according to the operation status of the walk-in function. For example, the icon setting unit 21 may display the execute icon with emphasis while moving the seat in the first movement direction. Also, the icon setting unit 21 may display the cancel icon with emphasis while moving the seat in the second movement direction. Here, “emphasis” includes blinking of icons (color inversion, brightness changes, etc.).

The icon setting unit 21 may set icons for operation buttons related to the folding function. For example, operation buttons related to the folding function include a FOLD button that executes folding of the backrest, an UNFOLD button that executes unfolding of the backrest, and a STOP button that stops folding/unfolding of the backrest. The icon setting unit 21 may set a “FOLD icon” (third icon) corresponding to the FOLD button, an “UNFOLD icon” (fourth icon) corresponding to the UNFOLD button, and a “STOP icon” corresponding to the STOP button.

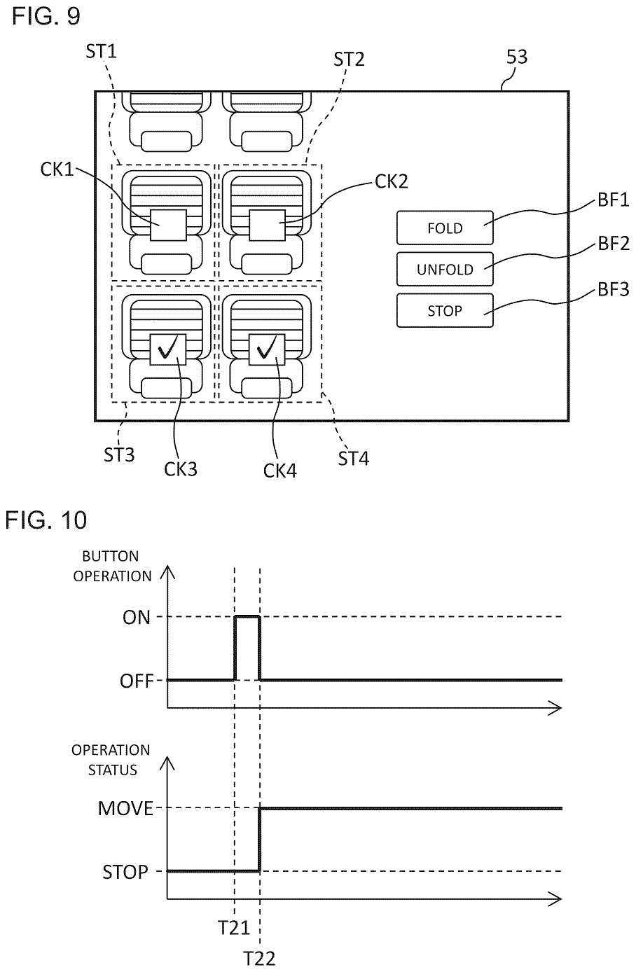

FIG. 9 shows an example of the “FOLD icon,” “UNFOLD icon,” and “STOP icon.” FIG. 9 shows FOLD icon BF1, UNFOLD icon BF2, and STOP icon BF3.

The icon setting unit 21 may change icons of operation buttons related to the folding function according to the operation status of the folding function. For example, the icon setting unit 21 may display the FOLD icon with emphasis while tilting the backrest in the first movement direction. Also, the icon setting unit 21 may display the UNFOLD icon with emphasis while returning the backrest in the second movement direction. Here, “emphasis” includes blinking of icons (color inversion, brightness changes, etc.).

In addition, the icon setting unit 21 may change icons of operation buttons related to the walk-in function or folding function according to the shift range status of the vehicle.

For example, the icon setting unit 21 may set execute icon, cancel icon, and stop icon for display when the vehicle's shift range is in P range (parking range). And the icon setting unit 21 may change execute icon, cancel icon, and stop icon to non-display or to a display state indicating inoperability when the vehicle's shift range is other than P range. As a “display state indicating inoperability,” for example, they may be grayed out.

Similarly, the icon setting unit 21 may set FOLD icon, UNFOLD icon, and STOP icon for display when the vehicle's shift range is in P range (parking range). And the icon setting unit 21 may change FOLD icon, UNFOLD icon, and STOP icon to non-display or to a display state indicating inoperability when the vehicle's shift range is other than P range. As a “display state indicating inoperability,” for example, they may be grayed out.

The screen setting unit 23 combines various icons set/changed by the icon setting unit 21 to set user interface screens. The set user interface screens are displayed on the operation display unit 10.

For example, as shown in FIG. 3, the screen setting unit 23 sets a user interface screen 51 for the walk-in function. FIG. 3 shows how execute icon BW11, cancel icon BW12, and stop icon BW 19 are arranged overlapping seat icon ST1 shown in FIG. 2. Also, FIG. 3 shows how execute icon BW21, cancel icon BW22, and stop icon BW29 are arranged overlapping seat icon ST2 shown in FIG. 2.

In this way, the screen setting unit 23 may arrange seat icons that are targets of the walk-in function and icons of operation buttons related to the walk-in function of the seat icons in an overlapping or adjacent manner.

The user interface screen 51 for the walk-in function is not limited to the example given here.

Also, as shown in FIG. 9, the screen setting unit 23 sets a user interface screen 53 for the folding function. FIG. 9 shows how FOLD icon, UNFOLD icon, and STOP icon are arranged next to the array of seat icons. Checkbox icons CK1 to CK4 are shown overlapping each seat icon ST1 to ST4. Here, checkbox icons CK1 to CK4 are displayed so that users can switch check on/off. Checkbox icons CK1 to CK4 indicate that they become targets of the folding function when checked on.

The user interface screen 53 for the folding function is not limited to the example given here.

In addition, the screen setting unit 23 may set popup windows that display various messages on the user interface screen.

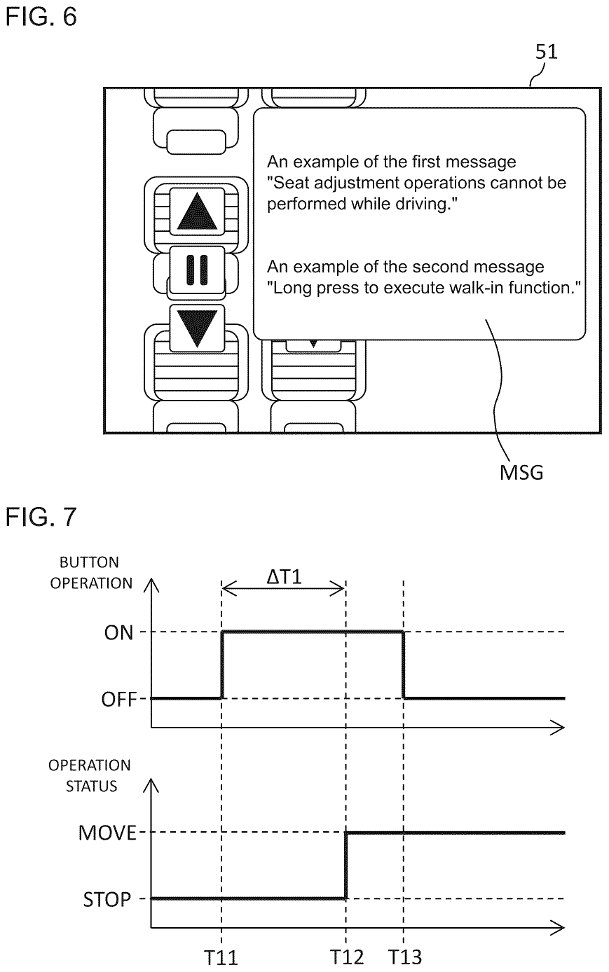

For example, the screen setting unit 23 may set a popup window that displays a message indicating that seat adjustment operations cannot be performed when the vehicle's shift range is other than P range or when the vehicle is traveling. FIG. 6 shows, as an example of the first message, the message “Seat adjustment operations cannot be performed while driving.”

Also, the screen setting unit 23 may set a popup window that displays a message serving as a hint about operations when there are operations on execute icon or cancel icon for less than a predetermined time. FIG. 6 shows, as an example of the second message, the message “Long press to execute walk-in function.”

Popup windows set by the screen setting unit 23 are not limited to the examples given here.

The operation acquisition unit 25 acquires user input operations on various icons displayed on the operation display unit 10.

When user interface screen 51 for the walk-in function is displayed on the operation display unit 10, the operation acquisition unit 25 acquires operations on execute icon, cancel icon, and stop icon respectively. Operations on the execute icon are referred to as execute operations (first operations), operations on the cancel icon as cancel operations (second operations), and operations on the stop icon as stop operations hereinafter.

When user interface screen 53 for the folding function is displayed on the operation display unit 10, the operation acquisition unit 25 acquires operations on FOLD icon, UNFOLD icon, and STOP icon respectively. Operations on the FOLD icon are referred to as folding operations (third operations), operations on the UNFOLD icon as unfolding operations (fourth operations), and operations on the STOP icon as folding stop operations hereinafter.

The operation acquisition unit 25 may acquire the duration of execute operations and the duration of cancel operations.

The drive instruction unit 27 generates control signals for the drive unit 30 based on acquired user input operations. That is, the drive instruction unit 27 generates drive instructions for adjusting vehicle seats and outputs them to the drive unit 30.

The drive instruction unit 27 moves the seat in the first movement direction based on execute operations (first operations) on the execute icon (first icon). Also, the drive instruction unit 27 moves the seat in the second movement direction based on cancel operations (second operations) on the cancel icon (second icon). Also, the drive instruction unit 27 stops seat movement based on stop operations on the stop icon.

Here, the drive instruction unit 27 may determine whether the duration of execute operations is equal to or longer than a predetermined time (whether first operations have been received for the predetermined time or longer). And when the duration of execute operations is equal to or longer than the predetermined time, the drive instruction unit 27 may start moving the seat in the first movement direction.

Also, the drive instruction unit 27 may determine whether the duration of cancel operations is equal to or longer than a predetermined time (whether second operations have been received for the predetermined time or longer). And when the duration of cancel operations is equal to or longer than the predetermined time, the drive instruction unit 27 may start moving the seat in the second movement direction.

The drive instruction unit 27 may stop seat movement when receiving stop operations.

In particular, the drive instruction unit 27 may continue seat movement after starting movement in the first movement direction until receiving stop operations or until reaching the end position for movement in the first movement direction. Whether the end position for movement in the first movement direction has been reached may be acquired by the state acquisition unit 29 described later.

Also, the drive instruction unit 27 may continue seat movement after starting movement in the second movement direction until receiving stop operations or until reaching the end position for movement in the second movement direction. Whether the end position for movement in the second movement direction has been reached may be acquired by the state acquisition unit 29 described later.

In addition, the drive instruction unit 27 may fold the backrest when receiving folding operations (third operations) on the FOLD icon (third icon). Also, the drive instruction unit 27 may unfold the backrest when receiving unfolding operations (fourth operations) on the UNFOLD icon (fourth icon).

The state acquisition unit 29 acquires various states of the vehicle via sensors not shown. For example, the state acquisition unit 29 may acquire whether the seat is at the end position for movement in the first movement direction via position sensors, or may acquire whether the seat is at the end position for movement in the second movement direction. Also, the drive instruction unit 27 may acquire whether the vehicle's shift range is in P range.

In addition, the state acquisition unit 29 may acquire the position and angle of each component constituting the seat by sensors not shown.

### Time Chart During Walk-In Function Execution

Next, regarding execute operations and cancel operations of the walk-in function, notes will be made using FIG. 7. FIG. 7 is a diagram showing a time chart when executing the walk-in function. As described above, when the duration of execute operations is equal to or longer than a predetermined time, the drive instruction unit 27 may start moving the seat in the first movement direction. Also, when the duration of cancel operations is equal to or longer than a predetermined time, the drive instruction unit 27 may start moving the seat in the second movement direction.

In FIG. 7, it is assumed that the execute button or cancel button is pressed at time T11 and continues to be pressed until time T13. In this case, at time T12 when predetermined time ΔT1 has elapsed from time T11, execution or cancellation of the walk-in function starts, and seat movement occurs.

In this way, since seat movement starts based on continuation of operations for predetermined time ΔT1 or longer, seat movement starting due to erroneous operations is suppressed.

On the other hand, the drive instruction unit 27 stops seat movement when receiving stop operations. Even when the stop button is not pressed continuously for predetermined time ΔT1, seat movement is stopped immediately, resulting in the ability to immediately reflect user intentions for seat stopping in seat adjustment.

### Flowchart During Walk-In Function Execution

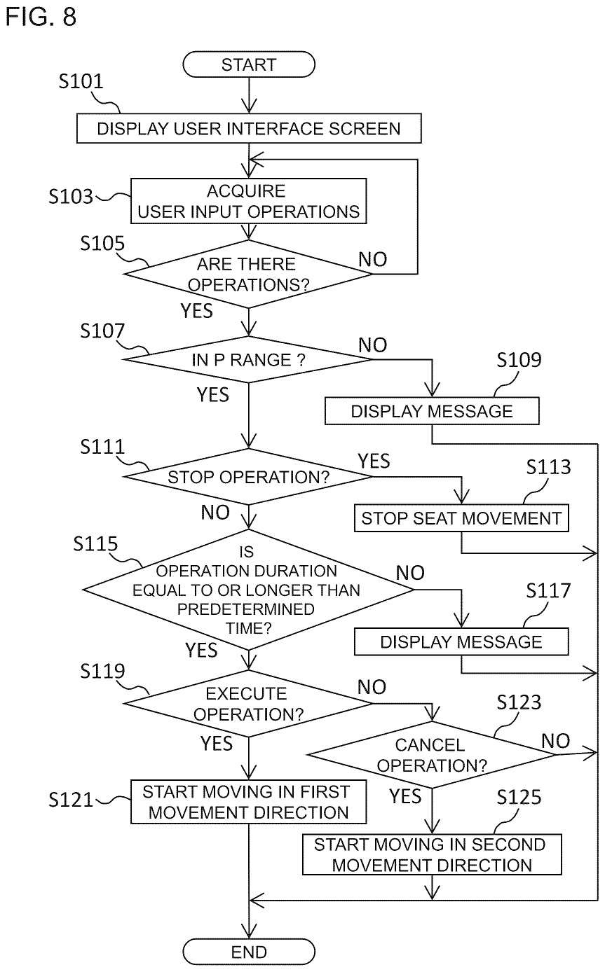

FIG. 8 is a flowchart showing the processing procedure when executing the walk-in function. For example, the processing shown in FIG. 8 is repeatedly executed while the vehicle's ignition key is on.

In step S101, the operation display unit 10 displays the user interface screen set by the screen setting unit 23.

In step S103, the operation acquisition unit 25 acquires user input operations on various icons displayed on the operation display unit 10.

In step S105, the operation acquisition unit 25 determines whether there are operations. When there are no operations (NO in step S105), the process returns to step S103.

When there are operations (YES in step S105), in step S107, the screen setting unit 23 determines whether the vehicle's shift range is in P range.

When the vehicle's shift range is other than P range (NO in step S107), in step S109, the screen setting unit 23 displays a message indicating that seat adjustment operations cannot be performed.

When the vehicle's shift range is in P range (YES in step S107), in step S111, the drive instruction unit 27 determines whether the operation is a stop operation.

When the operation is a stop operation (YES in step S111), in step S113, the drive instruction unit 27 stops seat movement.

When the operation is not a stop operation (NO in step S111), in step S115, the drive instruction unit 27 determines whether the operation duration is equal to or longer than a predetermined time.

When the operation duration is not equal to or longer than the predetermined time (NO in step S115), in step S117, the screen setting unit 23 displays a message serving as a hint about operations.

When the operation duration is equal to or longer than the predetermined time (YES in step S115), in step S119, the drive instruction unit 27 determines whether the operation is an execute operation.

When the operation is an execute operation (YES in step S119), in step S121, the drive instruction unit 27 starts moving the seat in the first movement direction. That is, it executes the walk-in function.

When the operation is not an execute operation (NO in step S119), in step S123, the drive instruction unit 27 determines whether the operation is a cancel operation.

When the operation is a cancel operation (YES in step S123), in step S125, the drive instruction unit 27 starts moving the seat in the second movement direction. That is, it cancels the walk-in function.

### Time Chart During Folding Function Execution

Next, regarding folding operations and unfolding operations of the folding function, notes will be made using FIG. 10. FIG. 10 is a diagram showing a time chart when executing the folding function.

In FIG. 10, it is assumed that the folding button or unfolding button is pressed at time T21 and released at time T22. In this way, the drive instruction unit 27 starts folding the backrest when receiving folding operations. Also, the drive instruction unit 27 starts unfolding the backrest when receiving unfolding operations. Even when the folding button or unfolding button is not pressed continuously, backrest folding or unfolding is performed immediately, resulting in the ability to immediately reflect user intentions in seat adjustment.

### Flowchart During Folding Function Execution

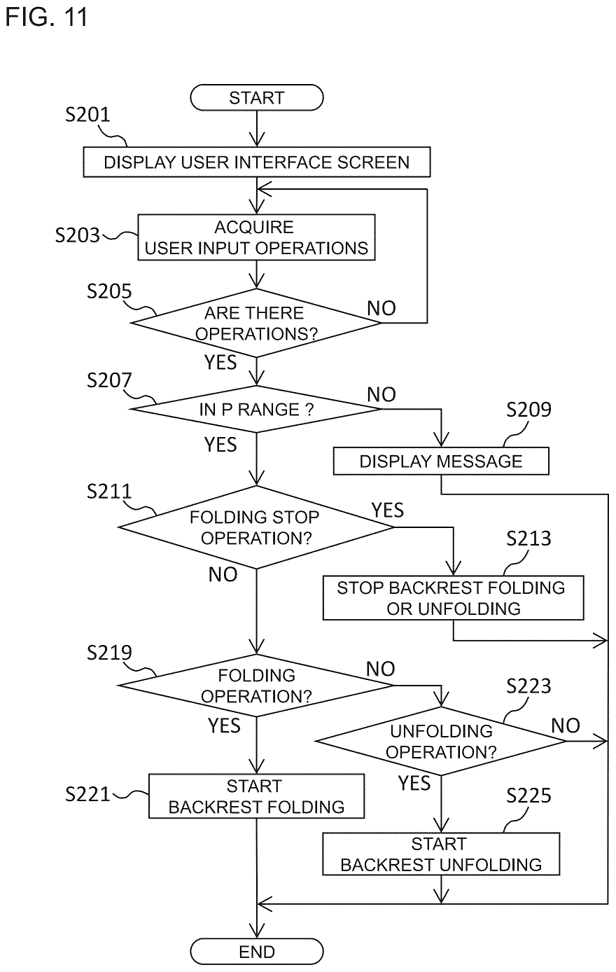

FIG. 11 is a flowchart showing the processing procedure when executing the folding function. For example, the processing shown in FIG. 11 is repeatedly executed while the vehicle's ignition key is on.

In step S201, the operation display unit 10 displays the user interface screen set by the screen setting unit 23.

In step S203, the operation acquisition unit 25 acquires user input operations on various icons displayed on the operation display unit 10.

In step S205, the operation acquisition unit 25 determines whether there are operations. When there are no operations (NO in step S205), the process returns to step S203.

When there are operations (YES in step S205), in step S207, the screen setting unit 23 determines whether the vehicle's shift range is in P range.

When the vehicle's shift range is other than P range (NO in step S207), in step S209, the screen setting unit 23 displays a message indicating that seat adjustment operations cannot be performed.

When the vehicle's shift range is in P range (YES in step S207), in step S211, the drive instruction unit 27 determines whether the operation is a folding stop operation.

When the operation is a folding stop operation (YES in step S211), in step S213, the drive instruction unit 27 stops backrest folding or unfolding.

When the operation is not a folding stop operation (NO in step S211), in step S219, the drive instruction unit 27 determines whether the operation is a folding operation.

When the operation is a folding operation (YES in step S219), in step S221, the drive instruction unit 27 starts backrest folding. That is, it executes the folding function.

When the operation is not a folding operation (NO in step S219), in step S223, the drive instruction unit 27 determines whether the operation is an unfolding operation.

When the operation is an unfolding operation (YES in step S223), in step S225, the drive instruction unit 27 starts backrest unfolding. That is, it cancels the folding function.

### Effects of Embodiment

As described in detail above, the seat control method and seat control device according to this embodiment display on an operation display unit: a seat icon indicating a seat mounted in a vehicle; a first icon indicating a first movement direction of the seat when activating the walk-in function of the seat; a second icon indicating a second movement direction opposite to the first movement direction; and a stop icon disposed between the first icon and the second icon. Based on a first operation on the first icon, the seat is moved in the first movement direction; based on a second operation on the second icon, the seat is moved in the second movement direction; and based on a stop operation on the stop icon, movement of the seat is stopped.

This makes it possible to simplify operations when realizing the walk-in function and suppress such operations from becoming complicated. In particular, it becomes unnecessary to perform operations for each of the seat cushion and backrest to realize the walk-in function that moves the positions of both the seat cushion and backrest forward in the vehicle. As a result, operations when realizing the walk-in function are simplified, and user convenience is improved.

Furthermore, since the first icon and second icon corresponding to the seat movement direction are displayed, users can understand the operation content by icons. Also, by positioning the stop icon between the first icon and the second icon, users can understand the operation content by icons. As a result, users can intuitively operate icons and instruct activation of the walk-in function of seats mounted in vehicles.

Also, the seat control method and seat control device according to this embodiment may advance the seat cushion of the seat and tilt the backrest of the seat forward when moving the seat in the first movement direction by the walk-in function. This makes it possible to realize instructions for movement of both the seat cushion and backrest accompanying the walk-in function with a single operation.

Furthermore, the seat control method and seat control device according to this embodiment may display seat icons with a first animation having movement corresponding to the first movement direction when moving the seat in the first movement direction. When moving the seat in the second movement direction, they may display seat icons with a second animation having movement corresponding to the second movement direction. This allows users to understand that the seat is moving. Furthermore, users can also understand the movement direction of the seat.

Also, the seat control method and seat control device according to this embodiment may start moving the seat in the first movement direction when receiving first operations for a predetermined time or longer. They may start moving the seat in the second movement direction when receiving second operations for a predetermined time or longer. Since seat movement starts based on continuation of operations for a predetermined time or longer, seat movement starting due to erroneous operations is suppressed. From the driver's seat or passenger seat operating the operation display unit, the area around the feet of seats that are targets of the walk-in function may be difficult to see, and preventing erroneous operations improves user convenience.

Furthermore, the seat control method and seat control device according to this embodiment may continue seat movement after starting movement in the first movement direction until receiving stop operations or until reaching the end position for movement in the first movement direction. After starting movement in the second movement direction, they may continue seat movement until receiving stop operations or until reaching the end position for movement in the second movement direction. This allows seat movement to continue even after the user touches the operation display unit, suppressing operations from becoming complicated when realizing the walk-in function.

Also, the seat control method and seat control device according to this embodiment may stop seat movement when receiving stop operations. This allows seat movement to be stopped immediately based on stop operations performed via the operation display unit, and user intentions for seat stopping can be immediately reflected in seat adjustment.

Furthermore, the seat control method and seat control device according to this embodiment may display the first icon with emphasis while moving the seat in the first movement direction. They may display the second icon with emphasis while moving the seat in the second movement direction. This allows users to understand that the seat is moving. Furthermore, users can also understand the movement direction of the seat.

Also, the seat control method and seat control device according to this embodiment may display the first icon and second icon when the vehicle's shift range is in Prange. They may change the first icon and second icon to non-display or to a display state indicating inoperability when the vehicle's shift range is other than P range. This allows users to understand that seat movement control is possible when the vehicle is in P range. Also, seat movement control is suppressed when the vehicle is in a range other than P range. Furthermore, users can understand that seat movement control cannot be performed when the vehicle is in a range other than P range.

Furthermore, the seat control method and seat control device according to this embodiment may display a third icon related to backrest folding and a fourth icon related to backrest unfolding on the operation display unit. When receiving third operations on the third icon, the backrest may be folded; when receiving fourth operations on the fourth icon, the backrest may be unfolded.

This allows backrest folding or unfolding to be performed immediately based on folding or unfolding operations performed via the operation display unit, and user intentions can be immediately reflected in backrest adjustment. Compared to situations where the area around the feet of seats that are targets of the walk-in function is difficult to see from the driver's seat or passenger seat operating the operation display unit, situations where the backrest of seats that are targets of folding or unfolding is difficult to see are less likely to occur. Therefore, there is less need to perform backrest folding or unfolding based on continuation of operations for a predetermined time or longer.

Each function shown in the above embodiment can be implemented by one or more processing circuits. Processing circuits include programmed processors, electrical circuits, etc., and further include devices such as application-specific integrated circuits (ASICs) and circuit components arranged to execute the described functions.

While the contents of the present disclosure have been described according to embodiments above, the present disclosure is not limited to these descriptions, and it is obvious to those skilled in the art that various modifications and improvements are possible. The discussions and drawings forming part of this disclosure should not be understood as limiting the present disclosure. Various alternative embodiments, examples, and operational techniques will be apparent to those skilled in the art from this disclosure.

The present disclosure naturally includes various embodiments not described here. Therefore, the technical scope of the present disclosure is determined only by the invention-specifying matters according to the claims that are reasonable from the above description.

### REFERENCE SIGNS LIST

10 operation display unit
20 controller
21 icon setting unit
23 screen setting unit
25 operation acquisition unit
27 drive instruction unit
29 state acquisition unit
30 drive unit

1. A seat control method for an operation display for controlling a seat mounted in a vehicle and a controller connected to the operation display, wherein the controller:
displays on the operation display:
a seat icon indicating the seat,
a first icon indicating a first movement direction of the seat when activating a walk-in function of the seat,
a second icon indicating a second movement direction opposite to the first movement direction, and
a stop icon disposed between the first icon and the second icon;
moves the seat in the first movement direction based on a first operation on the first icon;
moves the seat in the second movement direction based on a second operation on the second icon; and
stops movement of the seat based on a stop operation on the stop icon.

2. The seat control method according to claim 1, wherein the controller advances a seat cushion of the seat and tilts a backrest of the seat forward when moving the seat in the first movement direction by the walk-in function.

3. The seat control method according to claim 1, wherein the controller:
displays the seat icon with a first animation having movement corresponding to the first movement direction when moving the seat in the first movement direction, or
displays the seat icon with a second animation having movement corresponding to the second movement direction when moving the seat in the second movement direction.

4. The seat control method according to claim 1, wherein the controller:
starts movement of the seat in the first movement direction when receiving the first operation for a predetermined time or longer, or
starts movement of the seat in the second movement direction when receiving the second operation for a predetermined time or longer.

5. The seat control method according to claim 1, wherein the controller:
continues movement of the seat after starting movement of the seat in the first movement direction until receiving the stop operation or until reaching an end position for movement of the seat in the first movement direction, or
continues movement of the seat after starting movement of the seat in the second movement direction until receiving the stop operation or until reaching an end position for movement of the seat in the second movement direction.

6. The seat control method according to any one of claims 1 to 5, wherein the controller stops movement of the seat when receiving the stop operation.

7. The seat control method according to claim 1, wherein the controller:
displays the first icon with emphasis while moving the seat in the first movement direction, or
displays the second icon with emphasis while moving the seat in the second movement direction.

8. The seat control method according to claim 1, wherein the controller:
displays the first icon and the second icon when a shift range of the vehicle is in parking range, and
changes the first icon and the second icon to non-display or to a display state indicating inoperability when the shift range of the vehicle is other than parking range.

9. The seat control method according to claim 1, wherein the controller:
displays on the operation display:
a third icon related to folding of a backrest of the seat, and
a fourth icon related to unfolding of the backrest;
folds the backrest when receiving a third operation on the third icon; and
unfolds the backrest when receiving a fourth operation on the fourth icon.

10. A seat control device comprising an operation display for controlling a seat mounted in a vehicle and a controller connected to the operation display, wherein
the operation display displays:
a seat icon indicating the seat,
a first icon indicating a first movement direction of the seat when activating a walk-in function of the seat,
a second icon indicating a second movement direction opposite to the first movement direction, and
a stop icon disposed between the first icon and the second icon; and
the controller:
moves the seat in the first movement direction based on a first operation on the first icon;
moves the seat in the second movement direction based on a second operation on the second icon; and
stops movement of the seat based on a stop operation on the stop icon,
